(19) United States
(12) Patent Application Publication
(10) Pub. No.: US 2020/0410494 A1
(43) Pub. Date: Dec. 31, 2020

(54) Systems and Methods of Electronic Identity Verification

(71) Applicant: Moneris Solutions Corporation, Toronto (CA)

(72) Inventors: Shem ALI, Toronto (CA); Amer MATAR, Toronto (CA)

(21) Appl. No.: 17/016,076

(22) Filed: Sep. 9, 2020

Related U.S. Application Data
(63) Continuation of application No. PCT/CA2018/051284, filed on Oct. 12, 2018.
(60) Provisional application No. 62/641,086, filed on Mar. 9, 2018.

(51) Int. Cl. G06Q 20/40; G06Q 20/38; G06F 16/955; H04L 9/08

(52) U.S. Cl. CPC G06Q 20/4014; G06Q 20/3829; G06Q 20/3821; G06Q 2220/00; H04L 9/0825; H04L 2209/56; G06F 16/955

(57) ABSTRACT

System, devices and methods of verifying an electronic identity provided. A cardholder device method comprises receiving an input of an element associated with a transaction identifier for a transaction, establishing with an acquirer application a secure transmission connection, receiving from the acquirer application a request for a secure cardholder identification, receiving an input comprising the secure cardholder identification, and sending the acquirer application the input comprising the secure cardholder identification. A merchant device method comprises displaying an element associated with a transaction identifier for a transaction, receiving from an acquirer application a secure cardholder identification, and transmitting to a payment transition security device the secure cardholder identification. An acquirer system method comprises sending to a cardholder device a request for a secure cardholder identification, receiving from the cardholder device the secure cardholder identification, and transmitting to a merchant device the secure cardholder identification.

### CROSS-REFERENCE TO RELATED APPLICATIONS

This application is a continuation of PCT Application No. PCT/CA2018/051284 filed Oct. 12, 2018, which claims all benefit including priority to U.S. Provisional Patent Application 62/641,086 filed Mar. 9, 2018, and entitled: “System and Methods of Electronic Identity Verification,” both of which are hereby incorporated by reference in their entirety.

### FIELD

The present disclosure generally relates to the field of electronic payments, and in particular to system and methods of electronic identity verification.

### INTRODUCTION

Electronic payments may be made where a fully standalone, secure point of sale terminal (e.g., a handheld payment terminal) may be used to receive a cardholder's personal identification number (PIN) entry when making a purchase with a merchant.

### SUMMARY

In accordance with an embodiment, there is provided a merchant device comprising at least one processor configured to execute instructions, and a memory storing a sequence of instructions which when executed by the at least one processor perform a method of verifying an electronic identity. The at least one processor is configured to obtain a transaction identifier (ID) for a transaction between the merchant device and a cardholder-trusted device, display an element associated with the transaction identifier (ID), and receive a secure cardholder identification from an acquirer application, said secure cardholder identification received by the acquirer application from the cardholder-trusted device.

In accordance with another embodiment, there is provided a method of verifying an electronic identity. The method comprises obtaining at a merchant device a transaction identifier (ID) for a transaction between the merchant device and a cardholder-trusted device, displaying at the merchant device an element associated with the transaction identifier (ID), and receiving a secure cardholder identification from an acquirer application. The secure cardholder identification is received by the acquirer application from the cardholder-trusted device.

In accordance with another embodiment, there is provided a non-transitory computer-readable medium having instructions thereon which when executed by a processor perform a method of verifying an electronic identity. The method comprises obtaining a transaction identifier (ID) for a transaction between the merchant device and a cardholder-trusted device, displaying an element associated with the transaction identifier (ID), and receiving a secure cardholder identification from an acquirer application. The secure cardholder identification received by the acquirer application from the cardholder-trusted device.

In accordance with another embodiment, there is provided an electronic identity verification system. The system comprises at least one merchant device processor configured to execute instructions, at least one merchant device memory storing a sequence of instructions which when executed by the at least one processor perform a method of verifying an electronic identity, at least one acquirer system processor configured to execute instructions, at least one acquirer system memory storing a sequence of instructions which when executed by the at least one processor perform a method of verifying an electronic identity, at least one cardholder-trusted device processor configured to execute instructions, and at least one cardholder-trusted device memory storing a sequence of instructions which when executed by the at least one processor perform a method of verifying an electronic identity. The at least one merchant device processor is configured to send to an acquirer application a request for a transaction identifier (ID) for a transaction between the merchant device and a cardholder-trusted device, receive from the acquirer application, the transaction ID, display at the merchant device an element associated with the transaction identifier ID, and receive from the acquirer application the secure cardholder identification. The at least one acquirer system processor is configured to receive from the merchant device a request for a transaction identifier (ID) for a transaction between the merchant device and a cardholder-trusted device, obtain the transaction ID, send to the merchant device, the transaction ID, establish a secure transmission connection between the cardholder-trusted device and the acquirer application in response to receiving the element associated with the transaction ID, receive from the cardholder-trusted device the secure cardholder identification, and send to the merchant device the secure cardholder identification. The at least one cardholder-trusted device processor is configured to receive the element associated with the transaction ID and send to the acquirer application the secure cardholder identification.

In accordance with another embodiment, there is provided a method of verifying an electronic identity. The method comprises sending from a merchant device to an acquirer application a request for a transaction identifier (ID) for a transaction between the merchant device and a cardholder-trusted device, obtaining at the acquirer application the transaction ID, receiving at the merchant device from the acquirer application the transaction ID, displaying at the merchant device an element associated with the transaction identifier ID, receiving at the cardholder-trusted device the element associated with the transaction ID, establishing a secure transmission connection between the cardholder-trusted device and the acquirer application in response to receiving the element associated with the transaction ID, receiving at the acquirer application from the cardholder-trusted device the secure cardholder identification, and receiving at the merchant device from the acquirer application the secure cardholder identification.

In accordance with another embodiment, there is provided a non-transitory computer-readable medium having instructions thereon which when executed by at least one processor perform a method of verifying an electronic identity. The method comprises sending from a merchant device to an acquirer application a request for a transaction identifier (ID) for a transaction between the merchant device and a cardholder-trusted device, obtaining at the acquirer application the transaction ID, receiving at the merchant device from the acquirer application the transaction ID, displaying at the merchant device an element associated with the transaction identifier ID, receiving at the cardholder-trusted device the element associated with the transaction ID, establishing a secure transmission connection between the cardholder-trusted device and the acquirer application in response to receiving the element associated with the transaction ID, receiving at the acquirer application from the cardholder-trusted device the secure cardholder identification, and receiving at the merchant device from the acquirer application the secure cardholder identification.

In accordance with another embodiment, there is provided an acquirer application system. The system comprises at least one processor configured to execute instructions, and a memory storing a sequence of instructions which when executed by the at least one processor perform a method of verifying an electronic identity. The at least one processor is configured to receive from a merchant device a request for a transaction identifier (ID) associated with a transaction between the merchant device and a cardholder-trusted device, obtain the transaction ID, send the transaction ID to the merchant device, establish a secure transmission connection between the cardholder-trusted device and the acquirer application, receive the secure cardholder identification from the cardholder-trusted device, and transmit the secure cardholder identification to the merchant device. The secure transmission connection established in response to a the cardholder-trusted device receiving an element associated with the transaction ID.

In accordance with another embodiment, there is provided a method of verifying an electronic identity. The method comprises receiving at an acquirer application from a merchant device a request for a transaction identifier (ID) associated with a transaction between the merchant device and a cardholder-trusted device, obtaining at the acquirer application the transaction ID, sending from the acquirer application to the merchant device the transaction ID, establishing a secure transmission connection between the cardholder-trusted device and the acquirer application, receiving at the acquirer application from the cardholder-trusted device the secure cardholder identification, and transmitting from the acquirer application to the merchant device the secure cardholder identification. The secure transmission connection established in response to a the cardholder-trusted device receiving an element associated with the transaction ID.

In accordance with another embodiment, there is provided a non-transitory computer-readable medium having instructions thereon which when executed by a processor perform a method of verifying an electronic identity. The method comprises receiving from a merchant device a request for a transaction identifier (ID) associated with a transaction between the merchant device and a cardholder-trusted device, obtaining the transaction ID, sending to the merchant device the transaction ID, establishing a secure transmission connection with the cardholder-trusted device, receiving from the cardholder-trusted device the secure cardholder identification, and transmitting to the merchant device the secure cardholder identification. The secure transmission connection established in response to a the cardholder-trusted device receiving an element associated with the transaction ID.

In accordance with another embodiment, there is provided a cardholder-trusted device comprising at least one processor configured to execute instructions, and a memory storing a sequence of instructions which when executed by the at least one processor perform a method of verifying an electronic identity. The at least one processor is configured to receive an element associated with a transaction ID for a transaction between the cardholder-trusted device and a merchant device, establish a secure transmission connection with the acquirer application in response to receiving the element associated with the transaction ID, and send a secure cardholder identification to the acquirer application. The transaction ID is associated at an acquirer application with the transaction between the cardholder-trusted device and the merchant device. The secure cardholder identification is to be sent to the merchant device by the acquirer application.

In accordance with another embodiment, there is provided a method of verifying an electronic identity. The method comprises receiving at a cardholder-trusted device an element associated with a transaction ID for a transaction between the cardholder-trusted device and a merchant device, establishing a secure transmission connection with the acquirer application in response to receiving the element associated with the transaction ID, and sending from the cardholder-trusted device to the acquirer application a secure cardholder identification. The transaction ID is associated at an acquirer application with the transaction between the cardholder-trusted device and the merchant device. The secure cardholder identification is to be sent to the merchant device by the acquirer application.

In accordance with another embodiment, there is provided a non-transitory computer-readable medium having instructions thereon which when executed by a processor perform a method of verifying an electronic identity. The method comprises receiving an element associated with a transaction ID for a transaction between the cardholder-trusted device and a merchant device, establishing a secure transmission connection with the acquirer application in response to receiving the element associated with the transaction ID, and sending to the acquirer application a secure cardholder identification. The transaction ID is associated at an acquirer application with the transaction between the cardholder-trusted device and the merchant device. The secure cardholder identification is to be sent to the merchant device by the acquirer application.

In various further aspects, the disclosure provides corresponding systems and devices, and logic structures such as machine-executable coded instruction sets for implementing such systems, devices, and methods.

In this respect, before explaining at least one embodiment in detail, it is to be understood that the embodiments are not limited in application to the details of construction and to the arrangements of the components set forth in the following description or illustrated in the drawings. Also, it is to be understood that the phraseology and terminology employed herein are for the purpose of description and should not be regarded as limiting.

Many further features and combinations thereof concerning embodiments described herein will appear to those skilled in the art following a reading of the instant disclosure.

### DESCRIPTION OF THE FIGURES

Embodiments will be described, by way of example only, with reference to the attached figures, wherein in the figures:

FIG. 1 illustrates, in a component diagram, an example of an electronic identity verification architecture, in accordance with some embodiments.

FIG. 2 illustrates, in a flowchart, an example of a method of transferring a secure cardholder identification, in accordance with some embodiments.

FIG. 3 illustrates, in a component diagram, another example of an electronic identity verification system, in accordance with some embodiments.

FIG. 4 illustrates, in a flowchart, an example of a method of verifying an electronic identity, in accordance with some embodiments.

FIG. 5 illustrates, in a flowchart, another example of a method of verifying an electronic identity, in accordance with some embodiments.

FIG. 6 illustrates, in a flowchart, another example of a method of verifying an electronic identity, in accordance with some embodiments.

FIG. 7 illustrates, in a sequence diagram, another example of a method of transferring a secure cardholder identification, in accordance with some embodiments.

FIG. 8 illustrates, in a flowchart, an example of a method of verifying an electronic identity, in accordance with some embodiments.

FIG. 9 illustrates, in a component diagram, an example of a PoG architecture and typical dataflow.

FIG. 10 illustrates, in a component diagram, another example of an electronic identity verification architecture and typical dataflow, in accordance with some embodiments.

FIG. 11 illustrates, in a sequence diagram, another example of a method of verifying an electronic identity, in accordance with some embodiments.

FIG. 12 illustrates, in a block schematic diagram, an example of a computing device, according to some embodiments.

It is understood that throughout the description and figures, like features are identified by like reference numerals.

### DETAILED DESCRIPTION

Embodiments of methods, systems, and apparatus are described through reference to the drawings.

The following discussion provides example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

Personal Identification Number (PIN) On Glass (PoG) specifications provided by Payment Card Industry (PCI), entitled“Payment Card Industry (PCI) Software-based PIN entry on COTS Security Requirements, Version 1.0” (herein the“PoG Specification”) dated January 2018, as updated by PCI from time to time (hereby incorporated by reference), desire the removal of the need for a fully standalone, secure point of sale terminal (e.g., a handheld payment terminal) may be used to receive a cardholder's personal identification number (PIN) entry when making a purchase with a merchant. The specifications desire PIN entries to occur on off-the-shelf devices, such as commercial tablets, running PCI-compliant apps to receive the cardholder's PIN. While, the specifications provide an architecture and method for commercial devices to receive PINs from a merchant device, the specifications do not provide a method or architecture for receiving PINs from a trusted device.

Specifically, the current PIN On Glass specification does not provide a method or infrastructure for cardholders entering their personal PIN on their own devices (e.g., cardholder's tablet or phone). Cardholders may not trust or be comfortable entering personal information onto a device controlled by the merchant. The current PIN on Glass specification also does not provide ways for mitigating theft or damage of a merchant device. Merchants may not wish constant cardholder contact with expensive, delicate devices.

Embodiments disclosed herein describe a method by which the cardholder enters their PIN on a personal device, or any device they trust (e.g., a device belonging to a family member or a friend), rather than a device owned or controlled by the merchant, while maintaining a series of secure communications to protect PIN and cardholder data in order to facilitate a transaction.

Embodiments disclosed herein follows the PCI guidelines for PIN on Glass. However, they differ in that the cardholder enters their PIN on a device they trust (e.g., their own cell phone)—not the merchant's device.

The following terminology is used herein:

COTS—Commercial Off-The-Shelf (e.g., a commercially available device)

POS—Point-Of-Sale

MPOS—Mobile POS (e.g., a MPOS application residing on a COTS device)

PIN—Personal Identification Number

PoG—PIN on Glass (also known as mobile device PIN entry)

SPEA—Software-based PIN Entry Application

PCI—Payment Card Industry

PTS—Payment Transition Security

E2E—End-To-End

SRED—Secure Reading and Exchange of Data (e.g., a PCI PTS module establishing E2E encryption)

SDK—Software Development Kit

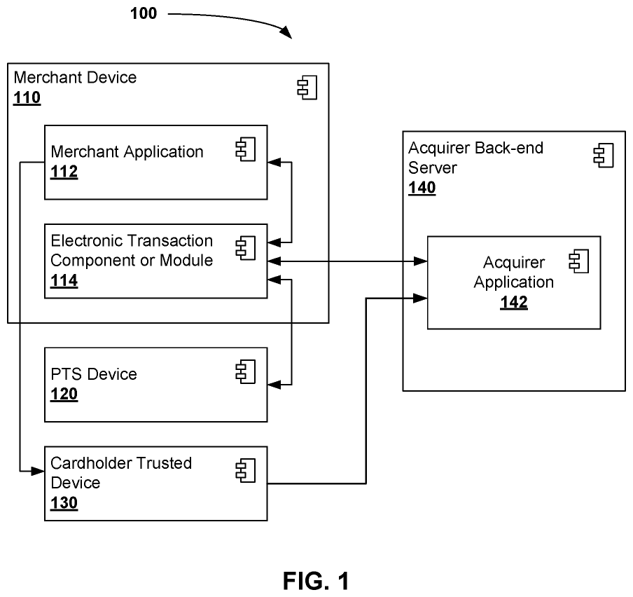

FIG. 1 illustrates, in a component diagram, an example of an electronic identity verification architecture 100, in accordance with some embodiments. The electronic identity verification architecture 100 includes a merchant device 110, a PTS device 120, a cardholder-trusted device 130 and an acquirer application 142 on a back-end server 140. An acquirer may be a bank, other financial institution, payment processor or other authorized entity that processes payment cards on behalf of a merchant. The merchant device 110 may be a smart phone or tablet that includes a merchant point of sale application 112 and an electronic transaction component or module 114 that communicates, by wire or wirelessly, with the acquirer application 142 on the back-end server 140. The term “electronic transaction component” may be used herein interchangeably with the term“electronic transaction module” (or“electronic transaction module or component”). In some embodiments, the electronic transaction module 114 may be a standalone application on the merchant device 110 that communicates with a merchant application 112, PTS device 120 and the back-end server 140. In other embodiments, the electronic transaction component 114 may be a software development kit (SDK) or library comprising code that is embedded into the merchant application 112. The code allows the merchant application 112 to communicate with the PTS device 120 and the back-end server 140. The merchant device 110 may also be paired with the PTS device 120 (i.e., paired, by wire or wirelessly, with a standalone chip card reader). Other components may be added to the electronic identity verification architecture 100.

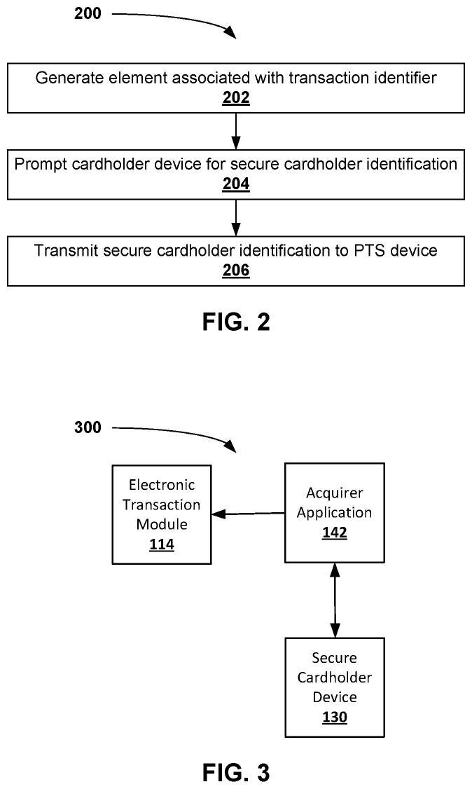

FIG. 2 illustrates, in a flowchart, an example of a method of transferring a secure cardholder identification 200, in accordance with some embodiments. Examples of secure cardholder identification include a PIN, and/or a biometric identifier (e.g., a finger print, retina scan, etc.). The method 200 may be performed by an acquirer application 142 running on the back-end server 140. Alternatively, aspects of the method 200 may be performed on a third party server, such as validation of the received secure identification. The method 200 comprises generating 202 a transaction identifier (ID) to be displayed at a merchant device 110, prompting 204 a cardholder device 130 for a secure cardholder identification, and transmitting 206 the secure cardholder identification to a PTS device 120. In some embodiments, the secure cardholder identification is passed through the electronic transaction module 114 to the PTS device 120. Other steps may be added to the method 200. Some steps in the method 200 will be described in greater detail below.

FIG. 3 illustrates, in a component diagram, another example of an electronic identity verification system 300, in accordance with some embodiments. The electronic identity verification system 300 comprises the electronic transaction module 114, the acquirer application 142 and the cardholder-trusted device 130. As noted above, an acquirer may be a bank, other financial institution, payment processor or other authorized entity that processes payment cards on behalf of a merchant. The acquirer application 142 may be executed by at least one processor on an acquirer server in an acquirer system. The electronic transaction module 114 communicates with the acquirer application 142 and a PTS device 120 application. The electronic transaction module 114 may reside on a merchant device 110 and may be part of a merchant application 112 or separate from a merchant application 112.

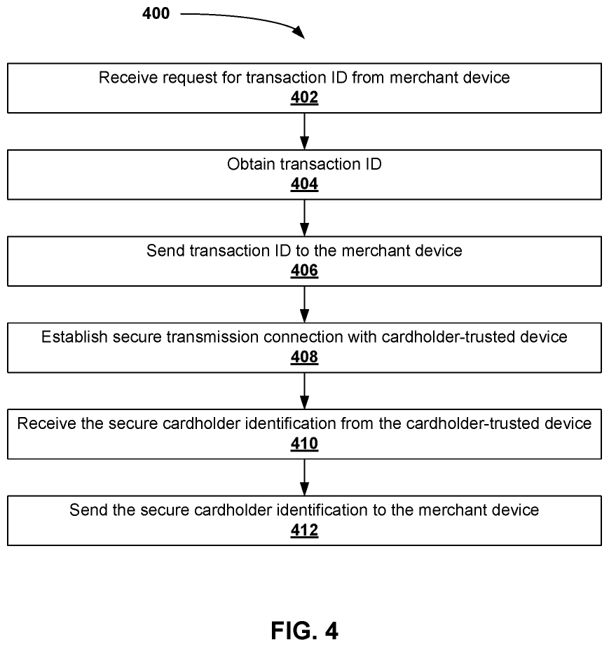

FIG. 4 illustrates, in a flowchart, an example of a method of verifying an electronic identity 400, in accordance with some embodiments. The method 400 may be performed by the acquirer application 142. The acquirer back-end server 140 may comprise at least one processor configured to execute instructions, and a memory storing a sequence of instructions which, when executed by the at least one processor, carry out the method of verifying an electronic identity 400. The method 400 comprises receiving 402, from a merchant device, a request for a transaction identifier (ID) associated with a transaction between the merchant device and a cardholder-trusted device. A transaction ID may then be obtained 404 at the acquirer application. In some embodiments, the transaction ID is generated at the acquirer application 142. In other embodiments, the transaction ID is received from the merchant device 110. Next, the acquirer application 142 sends 406 the transaction ID to the merchant device 110. Next a secure connection is established 408 between the acquirer application 142 and the cardholder-trusted device 130. The secure transmission connection is established in response to a cardholder-trusted device 130 receiving an element associated with the transaction ID. In some embodiments, the acquirer application 142 may send (e.g., transmit) to a cardholder-trusted device 130, a request for a secure cardholder identification. Examples of secure cardholder identification include a PIN, and/or a biometric identifier (e.g., a digital representation of a finger print, a digital representation of a retina scan, etc.). The acquirer application 142 may then receive 410, from the cardholder-trusted device 130, the secure cardholder identification. The acquirer application 142 may then send (e.g., transmit) 412, to a merchant device 110 (e.g., to an electronic transaction module 114 in the merchant device), the secure cardholder identification. Other steps may be added to the method 400, including associating the secure cardholder identification with a transaction identifier, as will be described in further detail below.

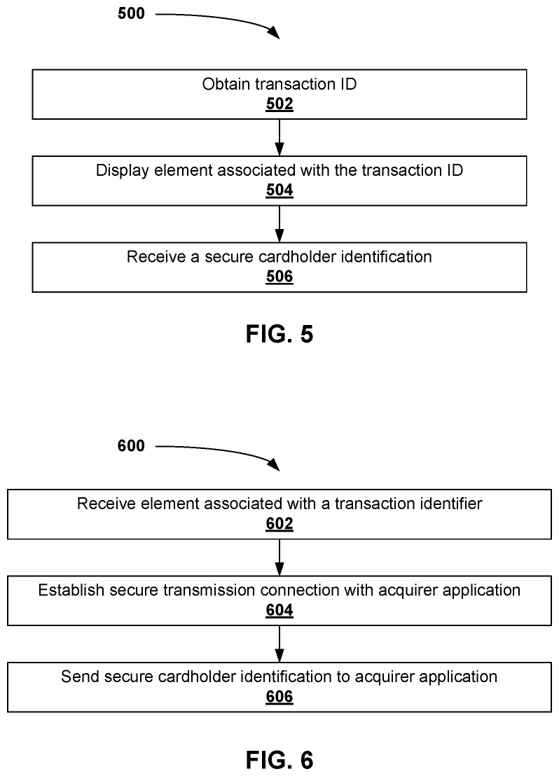

FIG. 5 illustrates, in a flowchart, another example of a method of verifying an electronic identity 500, in accordance with some embodiments. The method 500 may be performed by a merchant device 130. The merchant device 110 may comprise at least one processor configured to execute instructions, and a memory storing a sequence of instructions which, when executed by the at least one processor, carry out the method of verifying an electronic identity 500. The method 500 comprises obtaining 502 a transaction identifier (ID) for a transaction between the merchant device 110 and a cardholder-trusted device 130. The transaction ID may be received from the acquirer application 142 or generated at the merchant device 110. The merchant device 110 may then display 504 an element associated with the transaction ID. The element may be received from the acquirer application 142 or generated at the merchant device 110 by either the merchant application 112 or the electronic transaction component or module 114. In some embodiments, the merchant application 112 controls the display 504 of the element, in other embodiments, the electronic transaction component or module 114 controls the display 504 of the element. Next, the merchant device may receive 506 a secure cardholder identification from an acquirer application 142. Other steps may be added to the method 500, such as the merchant device sending (e.g., transmitting) the secure cardholder identification to a PTS device 120, as will be described in further detail below.

FIG. 6 illustrates, in a flowchart, another example of a method of verifying an electronic identity 600, in accordance with some embodiments. The method 600 may be performed by a cardholder-trusted device 130. The cardholder-trusted device 130 may comprise at least one processor configured to execute instructions, and a memory storing a sequence of instructions which, when executed by the at least one processor, carry out the method of verifying an electronic identity 600. The method 600 comprises receiving 602 an element associated with a transaction ID. The transaction ID is associated, at an acquirer application 142, with a transaction between the cardholder-trusted device 130 and the merchant device 110. Next, the cardholder device 130 may establish 604 a secure transmission connection with the acquirer application 142 in response to receiving the element associated with the transaction ID. The cardholder device 130 may then send 606 the secure cardholder identification to the acquirer application 142. Other steps may be added to the method 600, such as the cardholder-trusted device 130 receiving from the acquirer application a request for a secure cardholder identification, and the cardholder-trusted device 130 receiving an input comprising the secure cardholder identification, as will be described in further detail below.

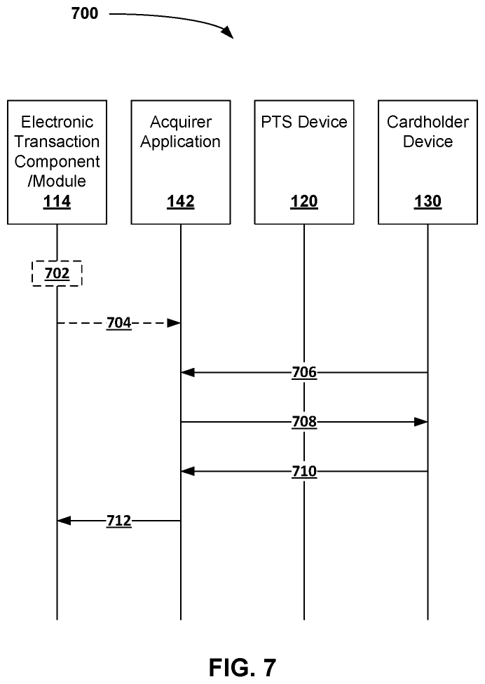

In some embodiments, the secure cardholder identification may be securely transmitted, such as via digital encryption. For example, a PIN or a digital representation of a biometric identifier may be encrypted using public/private key pairs. FIG. 7 illustrates, in a sequence diagram, another example of a method of transferring a secure cardholder identification 700, in accordance with some embodiments. The method 700 may be performed by an acquirer application 142 running on the back-end server 140. Alternatively, aspects of the method 700 may be performed on a third party server, such as validation of the received secure identification. The method 700 comprises receiving 706 a transaction request from a cardholder device 130, sending 708 the public key to the cardholder device 130, receiving 710 a secure cardholder identification that is encrypted using the public key from the cardholder device 130, and sending 712 the encrypted secure cardholder identification to the electronic transaction component or module 114. It is noted that methods 200, 400, 500 and 600 may be modified to incorporate steps of method 700, or used in conjunction with method 700.

Other steps may be added to the method 700, such as generating 702 a public/private key pair at the electronic transaction component or module 114, and receiving 704 the public key and a transaction identifier from the electronic transaction component or module 114. Alternatively, the private key may be generated at the backend server 140, and the secure cardholder identification unencrypted by the back-end server 140 and encrypted using pre-determined encryption means between the back-end server 140 to the electronic transaction component or module 114. In another alternative embodiment, the PTS device 120 may obtain (receive or generate) a public/private key pair. The PTS device 120 may then send the public key to the electronic transaction component or module 114, which then sends the public key to the back-end server 140. The back-end server 140 may then send the public key to the consumer device 130 to encrypt the PIN.

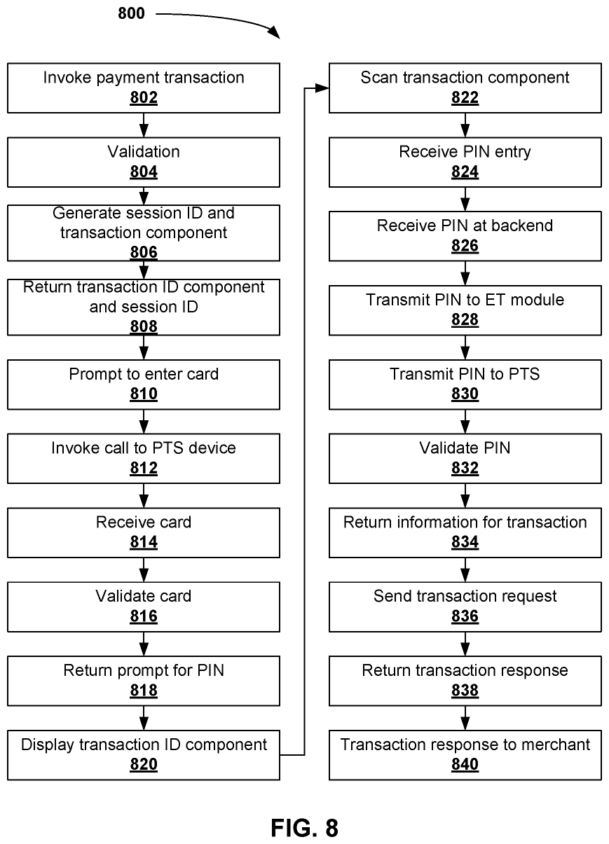

FIG. 8 illustrates, in a flowchart, an example of a method of verifying an electronic identity 800, in accordance with some embodiments. A merchant point of sale application 112 may invoke a payment transaction 802 to the electronic transaction component or module 114. The electronic transaction component or module 114 may connect to an acquirer application 142 on the back-end server 140 to validate 804 the electronic transaction component or module 114 and merchant credentials. The validation request 804 may comprise requesting a transaction identifier (ID) for the payment transaction. The acquirer application 142 on the back-end server 140 may generate 806 a unique transaction ID component and a payment session identifier (ID) (i.e., specific to the requested transaction) to the electronic transaction component or module 114. It should be understood that the session ID may be separate from the transaction ID, include the transaction ID, or be the transaction ID. In some embodiments, the unique transaction ID component may be a unique Quick Response (QR) code, be generated based on a QR code, or otherwise associated with a QR code. In some embodiments, the unique transaction ID component may be a URL link. In some embodiments, the unique transaction ID component may be transmitted to a memory location accessible by an application on a trusted cardholder device 130. In some embodiments, the transaction ID component may be represented as a string of alphanumeric characters, or some other representation. In some embodiments, a QR code may be an example of a transaction ID, or an element associated with the transaction ID, that is generated 202 by the acquirer application 142 on the back-end server 140 as shown in the method 200 of FIG. 2. In some embodiments, the QR code may be an example of an element, associated with the transaction ID, that is generated by the electronic transaction component or module 114, or the merchant application 112, on the merchant device 110. In such embodiments, the transaction ID is received from the acquirer application 142 and the element generated by the electronic transaction component or module 114 is associated with the transaction ID. In some embodiments, the electronic transaction component or module 114 may also generate a public/private key pair described in FIG. 7.

The electronic transaction (ET) component or module 114 may then return 808 the unique transaction ID component and payment session ID to the merchant application 112. In some embodiments, the public key described in FIG. 7 is sent to the back-end server 140. The merchant application 112 or the electronic transaction component or module 114 may then prompt 810 a cardholder to enter a card (e.g., a debit or credit card). The electronic transaction component or module 114 may then invoke 812 a call to the PTS device 120. It should be understood that in this step 812 there may be multiple messages (back and forth) between the PTS device 120 and the electronic transaction component or module 114 (e.g., device ready). Once the cardholder card is entered and read 814 by the PTS device 120, the PTS device 120 may validate the card and return 816 a prompt for the PIN (or other secure cardholder identification) to the electronic transaction component or module 114. The electronic transaction component or module 114 may then return 818 the prompt for the PIN (or other secure cardholder identification) to the merchant application 112. The merchant device 110 then displays 820 the unique transaction ID component (e.g., QR code).

The cardholder may obtain (e.g., access/receive) 822 the unique transaction ID component (e.g., by scanning a QR code) using the trusted cardholder device 130. In some embodiments where the unique transaction ID component is represented as a string of alphanumeric characters, a manual entry of the alphanumeric characters by a user on the device could perform the same function as a scan of a QR code. The unique transaction ID component may include information that causes the trusted cardholder device 130 to open a secure PIN (or other secure cardholder identification) entry display page served by the back-end server 140 in a browser or other application on the trusted cardholder device 130. In some embodiments, the secure PIN entry display page may be an example of prompting 204 a cardholder device 120 for a secure cardholder identification as shown in the method of FIG. 2. In some embodiments, the back-end server 140 may send the public key described in FIG. 7 to the trusted cardholder device 130 in this step.

The cardholder may enter their PIN (or other secure cardholder identification) on the trusted cardholder device 130. Once the trusted cardholder device 130 receives 824 the PIN (or other secure cardholder identification), the trusted cardholder device 130 sends 826 the PIN (or other secure cardholder identification) to an acquirer application 142 on the back-end server 140. In some embodiments, the secure cardholder identification may be encrypted using the public key as described in FIG. 7. The application on the back-end server 140 sends the PIN (or other secure cardholder identification) to the electronic transaction component or module 114 that then sends 830 the PIN (or other secure cardholder identification) to the PTS device 120. In some embodiments, step 830 is an example of the transmitting 206 the PIN to a PTS device as shown in the method 200 of FIG. 2. In some embodiments, the secure cardholder identification is sent encrypted using the public key to the electronic transaction component or module 114 that then decrypts the secure cardholder identification and sends it securely (e.g., encrypted using other means) to the PTS device 120.

The cardholder PIN (or other secure cardholder identification) is then validated 832 by the card in the PTS device 120. The PTS device 120 returns 834 card information used for the transaction (e.g., card number) to the electronic transaction component or module 114. The electronic transaction component or module 114 sends 836 the transaction request to the application 142 on the back end server 140 for processing. The application 142 on the back-end server 140 returns 838 a transaction response message to the electronic transaction component or module 114 and cardholder device 130. The electronic transaction component or module 114 returns 840 a transaction response to the merchant application 112. Other steps may be added to the method 800. Some steps in the method 800 will be further described below.

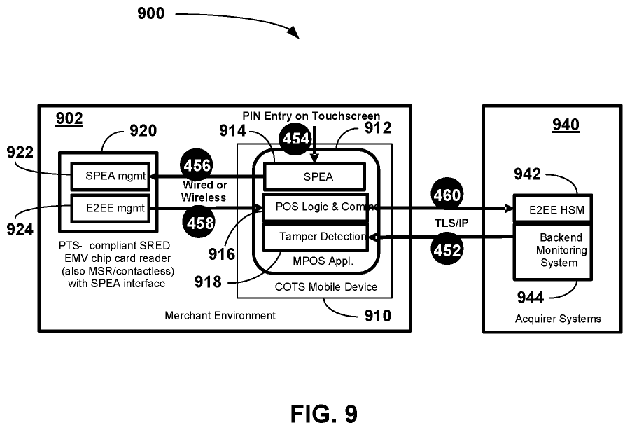

In some embodiments, PoG involves the entry of a cardholder's PIN by the cardholder during a chip card (e.g., a Europay, MasterCard™ and Visa™ (EMV) chip card) transaction on the screen of a COTS mobile smartphone or tablet. FIG. 9 illustrates, in a component diagram, an example of a PoG architecture 900 and typical dataflow, in accordance with the PoG Specification. The PoG architecture 900 comprises a merchant environment 902 and an acquirer system 940. The merchant environment 902 includes a PTS-compliant SRED EMV chip card reader 920 and a COTS mobile device 910. In some embodiments not described in the PoG Specification, other types of chip card readers may be used rather than EMV. The chip card reader 920 includes a SPEA management interface 922 and an E2E encryption (E2EE) management module 924. The COTS mobile device 910 includes an MPOS application 912 that includes a SPEA module 914, a POS logic and communication module 516, and a tamper detection module 918. The acquirer system 940 includes an E2EE Hardware Security Module (HSM) 942 and a back-end monitoring system 944.

In flow step 452, a real-time“backend monitoring system” 944 at the acquirer system 940 may verify that there are no issues with the COTS tamper detection module 918 prior to displaying the PIN entry screen for an EMV transaction. In some embodiments, PoG is not used for swipe, contactless or key entry modes. In flow step 454, the cardholder may use a COTS screen (e.g., tablet touchscreen) to enter their PIN into the SPEA module 914. In flow step 456, the SPEA module 914 may encrypt the PIN and send it to the PTS-compliant SRED card reader 920. In flow step 458, the PTS card reader 920 may decrypt the PIN. If the PIN is an EMV offline PIN, then the PTS card reader 920 may send the PIN to the EMV card for verification. If the PIN is an EMV online PIN, then the E2EE management module 924 may generate and send a Triple Data Encryption Standard (TDES) PIN block to the POS Logic and Communication module 916. In some embodiments, an assumption may be made that only offline PI Ns are used for EMV. In flow step 460, the MPOS application 912 may send the transaction message with E2EE data to the E2EE HSM in the acquirer system 940. In embodiments not described in the PoG Specification, other steps may be performed, including the sending of error messages when validation fails.

A traditional personal electronic device (PED) relies on “static” security, for example, tamper detection may cause key erasure. In some embodiments, PoG PIN entry relies on“dynamic” security, especially the real-time acquirer tamper checking prior to the display of a PIN entry screen. In some embodiments, PoG may involve a traditional PTS PED for card read functions.

New and non-traditional security measures may be applied to protect the MPOS application in general, and the SPEA in particular (versus a traditional PED). In some embodiments, real-time tamper detection of the COTS device may be managed by the acquirer back-end system (e.g., acquirer back-end application 142, acquirer system 140, 540). Also, there may be reliance on code obfuscation (“scrambling”) and multiple layers of credentials. Furthermore, “White box cryptography”, which is a technique for obfuscating crypto algorithms, may be used.

It is noted that in PoG, the MPOS application may be updated relatively rapidly to fix flaws in comparison to a traditional“static” PED. It should be understood that PoG on COTS devices should not be confused with traditional PEDs using hardened PoG built from commercially available touchscreen smart phones and tablets.

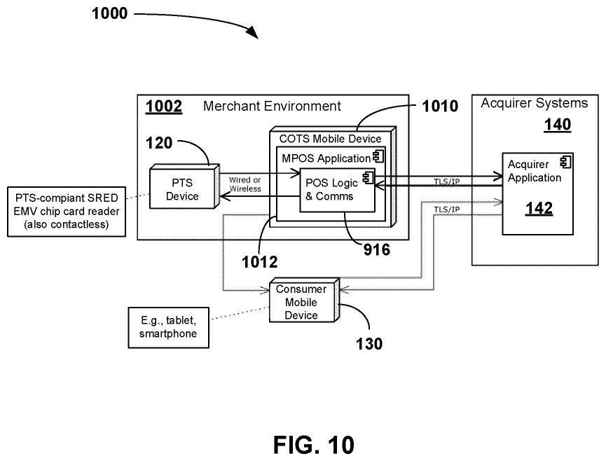

FIG. 10 illustrates, in a component diagram, another example of an electronic identity verification architecture 1000 and typical dataflow, in accordance with some embodiments. The PoG Specification architecture 900 shown in FIG. 9 could be amended accordingly to allow for trusted PIN verification as described herein. The electronic identity verification architecture 1000 comprises a merchant environment 1002 and an acquirer systems 140. The merchant environment 1002 includes a PTS device 120 and a COTS mobile device 1010. The PTS device 120 may be a PTS-compliant SRED EMV chip card reader, and in some embodiments may be contactless. The COTS mobile device 1010 includes an MPOS application 1012 that includes a POS logic and communication module 916. The acquirer system 140 includes an acquirer application 142. The environment 1000 also includes a cardholder device (e.g., consumer mobile device such as a tablet, smartphone, etc.) 130 that communicates with the merchant environment 1002 and the acquirer system 140.

The PTS device 120 communicates via wired or wireless communication with the POS Logic and Comm unit 916. The POS Logic and Comm unit 916 also communicates via transport layer security (TLS)/Internet protocol (IP) with the back-end system 140. The back-end system 140 also communicates via TLS/IP with the cardholder device 130 to pass the secure cardholder identification to allow a cardholder to input their secure cardholder identification (e.g., PIN) on their own trusted device 130 rather than on the merchant's COTS mobile device 120. The cardholder device 130 communicates with the COTS mobile device 1010 to receive the prompt for the secure cardholder identification.

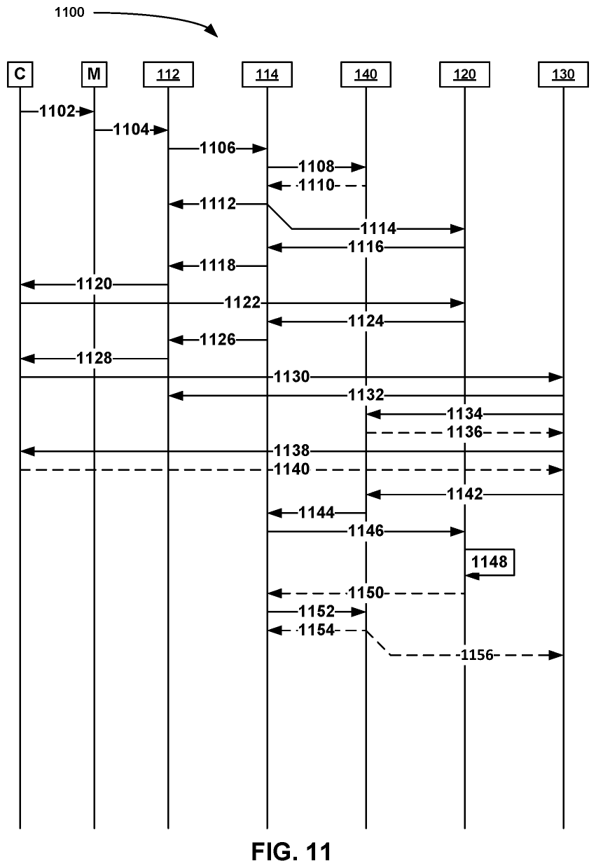

FIG. 11 illustrates, in a sequence diagram, another example of a method of verifying an electronic identity 1100, in accordance with some embodiments. A cardholder may wish to make an electronic purchase transaction at a merchant 1102. The merchant may then initiate a purchase transaction 1104 at a merchant application 112. The merchant application 112 may send (e.g., transmit) a payment transaction invocation message 1106 to an electronic transaction component or module 114. The electronic transaction component or module 114 may send (e.g., transmit) an electronic transaction component or module and merchant credentials validation request message 708 to a back-end server 140 application 142. In some embodiments, the electronic transaction component or module 114 may generate a public/private key pair and send the public key to the back-end server either before, during or after step 1108. The back-end server 140 application 142 may then send (e.g., transmit) a validation response message 1110 to the electronic transaction component or module 114. The validation response message may include a secure communication method code (e.g., a QR code associated with a transaction ID, other element associated with a transaction ID, or a transaction ID) and payment session ID associated with the purchase transaction. In some embodiments, a QR code or other element associated with the transaction ID may be generated and tied to the received secure communication method code. The electronic transaction component or module 114 may then send (e.g., transmit) the secure communication method code (e.g., a QR code) and payment session ID in a message 1112 to the merchant application 112. The electronic transaction component or module 114 may then send (e.g., transmit) a transaction request message 1114 to a PTS device 120. The PTS device 120 may then send (e.g., transmit) a PTS ready message 1116 to the electronic transaction component or module 114. The electronic transaction component or module 114 may then send (e.g., transmit) a PTS ready message 1118 to the merchant application 112. The merchant application 112 may then display an enter card prompt 1120 on the merchant device 110.

The PTS device 120 may then receive card information 1122 when a card is entered into the PTS device 120. The PTS device 120 may then send (e.g., transmit) a card validation and secure cardholder identification (e.g., a PIN) prompt message 1124 to the electronic transaction component or module 114. The electronic transaction component or module 114 may then send (e.g., transmit) a secure cardholder identification (e.g., PIN) prompt message 1136 to the merchant application 112. The merchant application 112 may then display the secure communication method code (e.g., a QR code) 1128 on the merchant device 110.

The trusted cardholder device (e.g., the cardholder device 130) may then be prompted to open a scanner associated with the secure communication code (i.e., a QR scanner) 1130 installed on the cardholder device 130. The cardholder device 130 may then scan the secure communication method code (e.g., a QR code) 1132 displayed by the merchant application 112. As noted above, in some embodiments, the scanning may be replaced with other means of inputting a representation of the secure communication code to the cardholder device. The secure communication method code (e.g., a QR code) may cause the cardholder device 130 to send an open uniform resource locator (URL) message 1134 to the back-end server 140 application 142. This message 1134 may be sent via a secure cardholder identification (e.g., PIN) entry display page served by the back-end server 140 in a browser or other application on the trusted cardholder device 130. The back-end server 140 application 142 may then send an open URL response message 1136 to the cardholder device 130. The message 1136 may include a prompt for a secure cardholder identification (e.g., PIN). The message 1136 may also include the public key. The cardholder device 130 may then display the ender secure cardholder identification (e.g., PIN) prompt 1138.

When the cardholder device 130 receives a secure cardholder identification (e.g., PIN) input 1140, the cardholder device 130 may send (e.g., transmit) a validation request message 1142 to the back-end server 140 application 142. The validation request message 1142 may include the secure cardholder identification (e.g., PIN). In some embodiments, the public key is used to encrypt a digital representation of the secure cardholder identification before sending it to the back-end server 140 application 142. The back-end server 140 application 142 may then send (e.g., transmit) a validation request message 1144 to the electronic transaction component or module 114. The electronic transaction component or module 114 may then send (e.g., transmit) a validation request message 1146 to the PTS device 120. The message 1146 may include the secure cardholder identification (e.g., PIN). In some embodiments, a digital representation of the secure cardholder identification that was encrypted using the public key may be decrypted using the corresponding private key generated by the electronic transaction component or module 114. The electronic transaction component or module 114 may transmit the secure cardholder identification (e.g., PIN) to the PTD device 120 in a secure manner. The PTS device 120 may then validate 1148 the secure cardholder identification (e.g., PIN). Once validated, the PTS device may then send a validation response message 1150 to the electronic transaction component or module 114. The response message 1150 may include the secure cardholder identification (e.g., PIN), a primary account number (PAN), any other device information required to complete a transaction authorization, and/or a verification confirmation indication. The electronic transaction component or module 114 may then send (e.g., transmit) a transaction authorization request message 1152 to the back-end server 140 application 142. The back-end server 140 application 142 may then send (e.g., transmit) a transaction response message 1154 to the electronic transaction component or module 114, and a transaction response message 1156 to the cardholder device 130. The electronic transaction component or module 114 may then send (e.g., transmit) a transaction response message to the merchant application 112 which, in turn, may display the transaction response 760 on the merchant device 110. Other steps may be added to the method 1100, including various action relating to purchase transaction that are not related to identity verification.

The electronic identity verification system and methods described above relate to the confidential and secure transfer of a secure cardholder identification (e.g., PIN) for a card on a trusted cardholder device 130. However, the system and methods described above may be amended to relate to the confidential and secure transfer of any payment scheme in place of the card and/or secure cardholder identification (e.g., PIN).

The electronic identity verification system and methods use the unique transaction identification (ID) generated by an electronic identity verification system for the transaction to be connected/communicated to the cardholder. The above embodiment provides an example using a generation of a QR code tied to the transaction ID, which the cardholder scans on their personal device to open a URL tied to the transaction ID.

In alternative embodiments, the QR code could be replaced with other communication. For example, a merchant may request the cardholder's cell phone number and that is used to generate an SMS message that includes the URL, directing the cardholder to tie in to the unique transaction ID that way.

It is understood that while a URL in a browser is common and convenient, there could be other means. The use of a URL may be generalized to any secure two-way form of computerized communication between the cardholder and the back-end server 140.

The entry of a secure cardholder identification (e.g., PIN) may be generalized to any identity verification by the cardholder, such as, for example, biometrics.

In some embodiments, neither QR code nor URL is used, but instead the unique transaction identity is tied to the cardholder via an account-based consumer application. For example, 1) a merchant initiates the transaction and a back-end server 140 creates a unique transaction ID (as above); 2) a cardholder has a standalone trusted application on his/her own device, and logs into their account; 3) via accessing their account, the cardholder receives access equivalent to the information in the URL link to enter their secure cardholder identification (e.g., PIN/biometrics), and the remaining steps proceed as in the above embodiment.

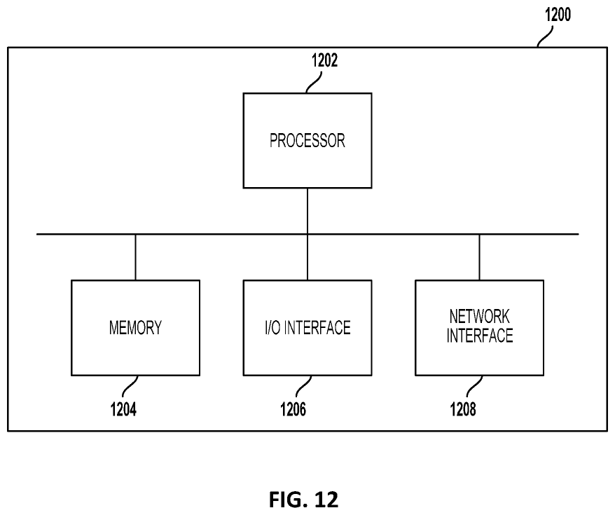

FIG. 12 illustrates, in a block schematic diagram, an example of a computing device 1200, according to some embodiments. There is provided a schematic diagram of computing device 1200, exemplary of an embodiment. As depicted, computing device 1200 includes at least one processor 1202, memory 1204, at least one I/O interface 1206, and at least one network interface 1208.

Each processor 1202 may be a microprocessor or microcontroller, a digital signal processing (DSP) processor, an integrated circuit, a field programmable gate array (FPGA), a reconfigurable processor, a programmable read-only memory (PROM), or any combination thereof.

Memory 1204 may include a computer memory that is located either internally or externally such as, for example, random-access memory (RAM), read-only memory (ROM), compact disc read-only memory (CDROM), electro-optical memory, magneto optical memory, erasable programmable read-only memory (EPROM), and electrically-erasable programmable read-only memory (EEPROM), Ferroelectric RAM (FRAM).

Each I/O interface 1206 enables computing device 1200 to interconnect with one or more input devices, such as a keyboard, mouse, camera, touch screen and a microphone, or with one or more output devices such as a display screen and a speaker. I/O interface 1206 may also include application programming interfaces (APIs) which are configured to receive data sets in the form of information signals, including verbal communications recorded and digitized, and/or text input from users in response to queries posed to said users.

Each network interface 1208 enables computing device 1200 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g., WiMAX), SS7 signaling network, fixed line, local area network, wide area network, and others. Network interface 1208, for example, may be used to communicate audio files (e.g., MP3, WAV, etc.) containing recorded verbal responses from a trusted cardholder device to the system for processing via a speech-to-text engine.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements.

Although the embodiments have been described in detail, it should be understood that various changes, substitutions and alterations can be made herein.

Moreover, the scope of the present application is not intended to be limited to the particular embodiments of the process, machine, manufacture, composition of matter, means, methods and steps described in the specification.

As can be understood, the examples described above and illustrated are intended to be exemplary only.

1. An electronic identity verification system comprising:
at least one merchant device processor configured to execute instructions;
at least one merchant device memory storing a sequence of instructions which, when executed by the at least one processor, perform a method of verifying an electronic identity;
wherein said at least one merchant device processor is configured to:
send, to an acquirer application system, a request for a transaction identifier (ID) for a transaction between the merchant device and a cardholder-trusted device;
obtain, from the acquirer application system, the transaction ID;
display, at the merchant device, an element associated with the transaction identifier ID; and
receive, from the acquirer application system, the secure cardholder identification;
at least one acquirer application system processor configured to execute instructions;
at least one acquirer application system memory storing a sequence of instructions which, when executed by the at least one processor, perform a method of verifying an electronic identity;
wherein said at least one acquirer application system processor is configured to:
receive, from the merchant device, a request for a transaction identifier (ID) for a transaction between the merchant device and a cardholder-trusted device;
obtain the transaction ID;
send, to the merchant device, the transaction ID;
establish a secure transmission connection between the cardholder-trusted device and the acquirer application in response to receiving the element associated with the transaction ID;
receive, from the cardholder-trusted device, the secure cardholder identification; and
send, to the merchant device, the secure cardholder identification; and at least one cardholder-trusted device processor configured to execute instructions;
at least one cardholder-trusted device memory storing a sequence of instructions which, when executed by the at least one processor, perform a method of verifying an electronic identity;
wherein said at least one cardholder-trusted device processor is configured to:
receive the element associated with the transaction ID; and
send, to the acquirer application system, the secure cardholder identification.

2. The electronic identity verification system as claimed in claim 1, wherein to obtain the transaction ID:
the at least one acquirer application system processor is further configured to: generate the transaction ID; and
the at least one merchant device processor is further configured to:
send, to the acquirer application system, the transaction ID to be associated with the transaction between the merchant device and the cardholder-trusted device;
receive, from the acquirer application system, confirmation that the transaction ID is associated with the transaction between the merchant device and the cardholder-trusted device.

3. The electronic identity verification system as claimed in claim 1, wherein to obtain the transaction ID, the at least one acquirer application system processor is further configured to:
receive, from the merchant device, the transaction ID to be associated with the transaction between the merchant device and the cardholder-trusted device;
associate the transaction ID to the transaction between the merchant device and the cardholder-trusted device; and
send, to the merchant device, confirmation that the transaction ID is associated with the transaction between the merchant device and the cardholder-trusted device.

4. The electronic identity verification system as claimed in claim 1, wherein:
the at least one acquirer application system processor is further configured to:
obtain a public key; and
send, to the cardholder-trusted device, the public key; and
the at least one cardholder-trusted device processor is further configured to:
receive, from the acquirer application system, the public key; and
prior to sending the secure cardholder identification to the acquirer application system, encrypt the secure cardholder identification with the public key.

5. The electronic identity verification system as claimed in claim 1, wherein:
the at least one merchant device processor is further configured to:
send, to the acquirer application, a public key;
the at least one acquirer application system processor is further configured to:
receive, from the merchant device, a public key; and
send, to the cardholder-trusted device, the public key; and
the at least one cardholder-trusted device processor is further configured to:
receive, from the acquirer application, a public key; and
prior to sending the secure cardholder identification to the acquirer application, encrypt the secure cardholder identification with the public key.

6. The electronic identity verification system as claimed in claim 1, wherein:
the at least one acquirer application system processor is further configured to:
generate the element associated with the transaction ID; and
send, to the merchant device, the element associated with the transaction ID; and
the at least one merchant device processor is further configured to:
receive the element associated with the transaction ID from the acquirer application.

7. The electronic identity verification system as claimed in claim 1, wherein:
the at least one acquirer application system processor is further configured to: receive, from the cardholder-trusted device, a request for the secure session for the transmission of the secure cardholder identification; and
send, to the cardholder-trusted device, a request for a secure cardholder identification; and
the at least one cardholder-trusted device processor is further configured to:
send, to the acquirer application, a request for the secure session for the transmission of the secure cardholder identification;
receive, from the acquirer application, a request for a secure cardholder identification; and
receive an input comprising the secure cardholder identification.

8. The electronic identity verification system as claimed in claim 1, wherein:
the at least one merchant device processor is further configured to:
send, to the acquirer application, an electronic transaction module and merchant credentials validation request message;
receive, from the acquirer application, a validation response message;
receive, from the acquirer application, a validation request message;
send, to the acquirer application, a transaction authorization request message; and
receive, from the acquirer application, a transaction authorization response message;
the at least one acquirer application system processor is further configured to:
receive, from the merchant device, an electronic transaction module and merchant credentials validation request message;
transmit, to the merchant device, a validation response message;
receive, from the cardholder-trusted device, a secure two-way communication request message;
transmit, to the cardholder-trusted device, an open URL response message;
receive, from the cardholder-trusted device, a validation request message;
transmit, to the merchant device, a validation request message;
receive, from the merchant device, a transaction authorization request message; and
transmit, to the merchant device, a transaction authorization response message; and
the at least one cardholder-trusted device processor is further configured to:
send, to the acquirer application, a secure two-way communication request message;
receive, from the acquirer application, an open URL response message; and
send, to the acquirer application, a validation request message.

9. A method of verifying an electronic identity, the method comprising:
sending, from a merchant device to an acquirer application, a request for a transaction identifier (ID) for a transaction between the merchant device and a cardholder-trusted device;
obtaining, at the acquirer application, the transaction ID;
receiving, at the merchant device from the acquirer application, the transaction ID;
displaying, at the merchant device, an element associated with the transaction identifier ID;
receiving, at the cardholder-trusted device, the element associated with the transaction ID;
establishing a secure transmission connection between the cardholder-trusted device and the acquirer application in response to receiving the element associated with the transaction ID;
receiving, at the acquirer application from the cardholder-trusted device, the secure cardholder identification; and
receiving, at the merchant device from the acquirer application, the secure cardholder identification.

10. The method as claimed in claim 9, wherein obtaining the transaction ID comprises:
sending, from the merchant device to the acquirer application, a request for the transaction ID;
generating, at the acquirer application, the transaction ID; and
receiving, at the merchant device from the acquirer application, the transaction ID.

11. The method as claimed in claim 9, wherein obtaining the transaction ID comprises:
sending, from the merchant device to the acquirer application, the transaction ID to be associated with the transaction between the merchant device and the cardholder-trusted device;
associating, at the acquirer application, the transaction ID to the transaction between the merchant device and the cardholder-trusted device; and
receiving, at the merchant device from the acquirer application, confirmation that the transaction ID is associated with the transaction between the merchant device and the cardholder-trusted device.

12. The method as claimed in claim 9, further comprising:
obtaining, at the acquirer application, a public key;
sending, from the acquirer application to the cardholder-trusted device, the public key; and
prior to the cardholder-trusted device sending the secure cardholder identification to the acquirer application, encrypting, at the cardholder-trusted device, the secure cardholder identification with the public key.

13. The method as claimed in claim 12, wherein obtaining the public key comprises one of:
receiving, from the merchant device at the acquirer application, the public key; or
generating, at the acquirer application, the public key.

14. The method as claimed in claim 9, further comprising:
sending, from the merchant device to the acquirer application, a public key;
sending, from the acquirer application to the cardholder-trusted device, the public key; and
prior to the cardholder-trusted device sending the secure cardholder identification to the acquirer application, encrypting, at the cardholder-trusted device, the secure cardholder identification with the public key.

15. The method as claimed in claim 9, further comprising:
generating, at the acquirer application, the element associated with the transaction ID; and
receiving, at the merchant device, the element associated with the transaction ID from the acquirer application.

16. The method as claimed in claim 9, further comprising:
generating, at the merchant device, the element; and
associating, at the merchant device, the element with the transaction ID.

17. The method as claimed in claim 9, further comprising:
receiving, at the acquirer application from the cardholder-trusted device, a request for the secure session for the transmission of the secure cardholder identification;
receiving, at the cardholder-trusted device from the acquirer application, a request for a secure cardholder identification; and
receiving, at the cardholder-trusted device, an input comprising the secure cardholder identification.

18. The method as claimed in claim 17, wherein the request for a secure session comprises at least one of:
receiving, at the acquirer application from the cardholder-trusted device, a request associated with a uniform resource locator (URL); or
receiving, at the acquirer application from the cardholder-trusted device, a request associated with a cardholder account form the cardholder-trusted device.

19. The method as claimed in claim 9, further comprising:
receiving, at the acquirer application from the merchant device, an electronic transaction module and merchant credentials validation request message;
transmitting, from the acquirer application to the merchant device, a validation response message;
receiving, at the acquirer application from the cardholder-trusted device, a secure two-way communication request message;
transmitting, from the acquirer application to the cardholder-trusted device, an open URL response message;
receiving, at the acquirer application from the cardholder-trusted device, a validation request message;
transmitting, from the acquirer application to the merchant device, a validation request message;
receiving, at the acquirer application from the merchant device, a transaction authorization request message; and
transmitting, from the acquirer application to the merchant device, a transaction authorization response message.

20. A non-transitory computer-readable medium having instructions thereon which, when executed by at least one processor, perform a method of verifying an electronic identity, said method comprising:
sending, from a merchant device to an acquirer application, a request for a transaction identifier (ID) for a transaction between the merchant device and a cardholder-trusted device;
obtaining, at the acquirer application, the transaction ID;
receiving, at the merchant device from the acquirer application, the transaction ID;
displaying, at the merchant device, an element associated with the transaction identifier ID;
receiving, at the cardholder-trusted device, the element associated with the transaction ID;
establishing a secure transmission connection between the cardholder-trusted device and the acquirer application in response to receiving the element associated with the transaction ID;
receiving, at the acquirer application from the cardholder-trusted device, the secure cardholder identification; and
receiving, at the merchant device from the acquirer application, the secure cardholder identification.
